(19) United States
(12) Patent Application Publication
(10) Pub. No.: US 2011/0311057 A1
(43) Pub. Date: Dec. 22, 2011

(54) AUDIO STREAM TRANSMISSION APPARATUS, AUDIO STREAM RECEPTION APPARATUS, AND TRANSMITTING AND RECEIVING METHOD THEREOF

(75) Inventor: Jakub Jan Jerzy JAMRO, Warszawa (PL)

(73) Assignee: SAMSUNG ELECTRONICS CO., LTD., Suwon-si (KR)

(21) Appl. No.: 13/166,064

(22) Filed: Jun. 22, 2011

(30) Foreign Application Priority Data
Jun. 22, 2010 (KR) 2010-0059018

(51) Int. Cl. H04R 5/00

(52) U.S. Cl. 381/1

(57) ABSTRACT

A single audio service includes a plurality of audio sources, which may be classified by type. The classified audio sources having a same type may be multiplexed together to form audio streams, which may be amplified to obtain a desired audio environment.

### CROSS-REFERENCE TO RELATED APPLICATIONS

This application claims priority from Korean Patent Application No. 2010-59018, filed in the Korean Intellectual Property Office on Jun. 22, 2010, the disclosure of which is incorporated herein by reference in its entirety.

### BACKGROUND

1. Field

Aspects of the exemplary embodiments relate to an audio stream transmission apparatus, an audio stream reception apparatus, and a method for transmitting and receiving thereof, and more particularly, to an audio stream transmission apparatus that composes and transmits a plurality of audio streams constituting audio service, an audio stream reception apparatus that receives and processes a plurality of audio streams constituting audio service, and a method for transmitting and receiving thereof.

2. Description of the Related Art

As digital broadcast is widely provided, various kinds of electronic apparatuses support digital broadcasting service. Particularly, in recent years, digital broadcasting service is supported not only by a digital broadcasting television or a set-top box, which is provided in an ordinary house, but also by a mobile phone, a navigation device, a PDA, or an MP3 player.

Conventionally, audio service of contents to be reproduced in a digital media apparatus include only one stream. Specifically, a plurality of audio sources constituting audio service of contents (for example, sound effect, background music, actor voice, and so forth) are amplified respectively, and the amplified audio sources are mixed to form a single channel (for example, right or left). The channel is multiplexed and audio service consists of a single audio stream including a plurality of channels.

However, if audio service consists of a single audio stream, as described above, a user may adjust output of only one audio stream.

In other words, a user may adjust only volume of an audio stream constituting one audio service, as illustrated in FIG. 1, and thus the user may not obtain a desired audio environment.

For example, a user may desire to hear an actor's voice, but the sound effects may output loudly, thus making the actor's voice difficult to discern. In this case, the user may not reduce the output of the sound effects and increase the output of the actor's voice. Instead, the user can only to decrease or increase the overall volume.

Accordingly, a method for providing audio service, in which a user may build a desired audio environment, is required.

### SUMMARY

An aspect of the exemplary embodiments relates to a stream transmission apparatus which composes a plurality of audio steams by classifying a plurality of audio sources constituting a single audio service by the type, and multiplexes each group of classified audio sources, and a transmitting method thereof.

Another aspect of the exemplary embodiments relates to a stream reception apparatus which receives and decodes a plurality of audio streams that are classified and multiplexed by the type of audio source, and a receiving method thereof.

According to an exemplary embodiment, a stream transmission apparatus includes a plurality of input units that respectively receive an audio source from among a plurality of audio sources of a single audio service and a plurality of multiplexers that classify each of the plurality of audio sources by type of audio source, group the plurality of classified audio sources having a same classified type together, and multiplex audio sources within the classified groups of audio sources together as a plurality of audio streams.

The stream transmission apparatus may further include a plurality of amplifiers that respectively amplify the plurality of audio sources received by the plurality of input units and respectively provide a plurality of amplified audio sources to the plurality of multiplexers.

Each of the plurality of multiplexers may classify a left source among the plurality of audio sources and a corresponding right source among the plurality of audio sources as a same type and multiplexes the classified left source and corresponding right source together.

The plurality of audio sources may include a left source and right source of at least one of an actor voice, a sound effect, and a background music.

Each of the plurality of multiplexers may classify the plurality of audio sources using a same language into a group according to language information of the plurality of audio sources and multiplex the classified audio sources having a same language together.

The stream transmission apparatus may further include a Reed-Solomon (RS) encoder which RS-encodes the plurality of audio streams multiplexed by the plurality of the multiplexers, an interleaver which interleaves the plurality of RS-encoded audio streams, a trellis-encoder which trellis-encodes the plurality of interleaved audio streams, and a modulator which modulates the plurality of trellis-encoded audio streams and outputs the plurality of modulated audio streams.

According to an exemplary embodiment, a stream transmitting method includes receiving a single audio service, the single audio service comprising a plurality of audio sources, classifying each the plurality of audio sources according to a type of each of the plurality of audio sources, grouping the plurality of classified audio sources having a same classified type together, and multiplexing audio sources within the classified groups of audio sources together as a plurality of audio streams.

The method may further include amplifying each of the received plurality of audio sources, and the multiplexing may include multiplexing amplified audio sources within the classified groups of amplified audio sources together as the plurality of audio streams.

The classifying may include classifying a left source among the plurality of audio sources and a right corresponding right source among the plurality of audio sources as a same type and the multiplexing may include multiplexing the classified left source and corresponding right source together.

The plurality of audio sources may include a left source and right source of at least one of an actor voice, a sound effect, and a background music.

The classifying may include classifying the plurality of audio sources using a same language into a group according to language information of the plurality of audio sources and the multiplexing may include multiplexing the classified audio sources having a same language together.

According to an exemplary embodiment, a stream reception apparatus includes a reception unit which receives a plurality of audio streams that form a single audio service and a decoder which decodes the plurality of audio streams, and each of the plurality of audio streams comprises a multiplexed audio stream, the multiplexed audio stream comprising a plurality of audio sources classified as a same type of audio source.

The stream reception apparatus may further include a controller which individually outputs each of the plurality of audio streams.

The stream reception apparatus may further include a user interface unit which receives a volume adjustment command that instructs the reception apparatus to adjust a volume of an audio source among the plurality of audio sources included in an audio stream among the plurality of audio streams, and the controller may control the stream reception apparatus to adjust the volume of the audio source and output the adjusted audio source in accordance with the volume adjustment command.

The user interface unit may include a plurality of volume adjustment bars corresponding to the plurality of audio streams.

According to an exemplary embodiment, a stream receiving method includes receiving a plurality of audio streams that form a single audio service and decoding the plurality of audio streams, and each of the plurality of audio streams comprises a multiplexed audio stream, the multiplexed audio stream comprising a plurality of audio sources classified as a same type of audio source.

The method may further include individually outputting each of the plurality of audio streams.

The method may further include receiving a volume adjustment command to adjust a volume of an audio source among the plurality of audio sources included in an audio stream among the plurality of audio streams, adjusting the volume of the audio source, and outputting the adjusted audio source in accordance with the input volume adjustment command.

### BRIEF DESCRIPTION OF THE DRAWINGS

The above and/or other aspects will be more apparent by describing certain exemplary embodiments with reference to the accompanying drawings, in which:

FIG. 1 is a schematic view illustrating a user interface to adjust audio volume of contents reproduced in a conventional contents reproducing apparatus;

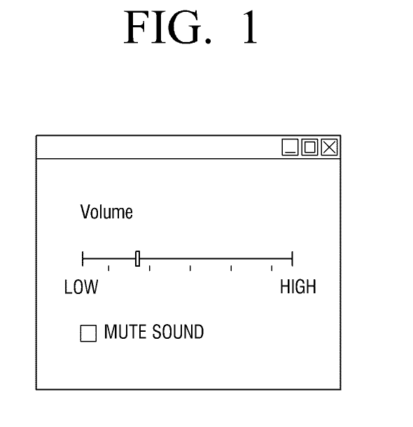

FIG. 2 is schematic block diagram of an audio stream transmission apparatus, according to an exemplary embodiment;

FIG. 3 is a block diagram illustrating a process of composing an audio stream of an audio stream transmission apparatus, according to an exemplary embodiment;

FIG. 4 is a schematic block diagram illustrating an audio reception apparatus, according to an exemplary embodiment;

FIG. 5 is a schematic view illustrating a user interface to adjust volume of audio contents reproduced in a contents reproducing apparatus, according to an exemplary embodiment;

FIG. 6 is a flowchart of transmitting an audio stream, according to an exemplary embodiment; and

FIG. 7 is a flowchart of receiving an audio stream, according to an exemplary embodiment.

### DETAILED DESCRIPTION OF EXEMPLARY EMBODIMENTS

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, the exemplary embodiments can be practiced without those specifically defined matters. Also, well-known functions or constructions are not described in detail, since they would obscure the application with unnecessary detail.

Audio Stream Transmission Apparatus

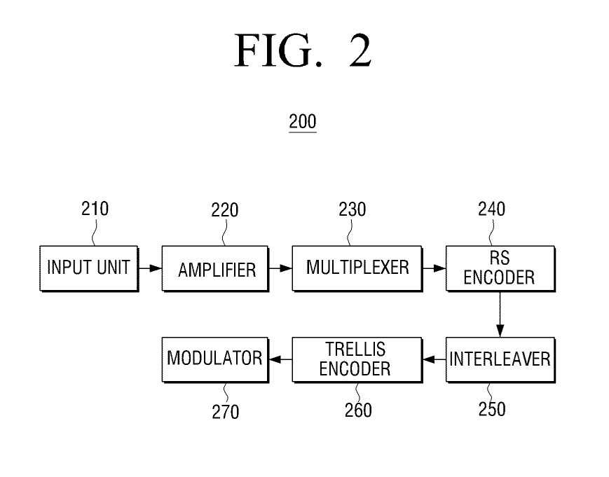

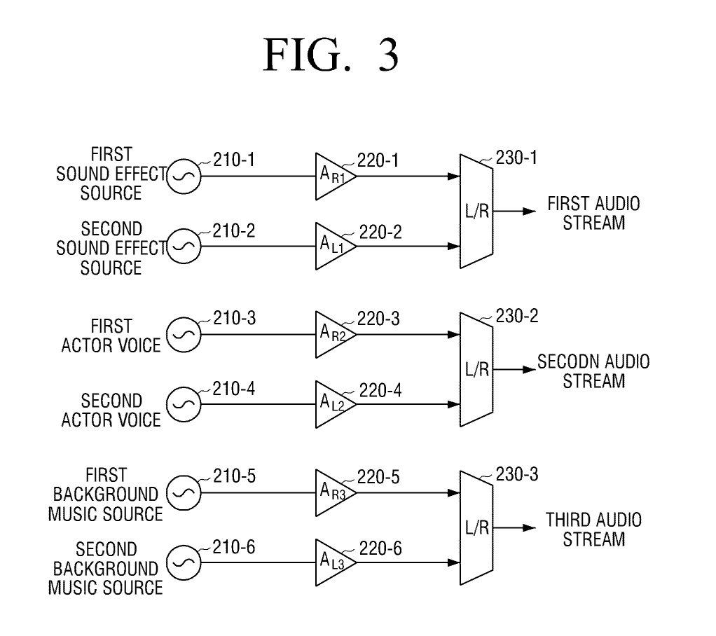

An audio stream transmission apparatus, according to an exemplary embodiment, will be explained with reference to FIGS. 2 and 3.

FIG. 2 is schematic block diagram of an audio stream transmission apparatus 200 according to an exemplary embodiment. As illustrated in FIG. 2, the audio stream transmission apparatus 200 comprises an input unit 210, an amplifier 220, a multiplexer 230, a Reed-Solomon (RS) encoder 240, an interleaver 250, a trellis encoder 260 and a modulator 270.

The input unit 210 receives a plurality of audio sources constituting a single audio service. Herein, the single audio service refers to audio provided from one digital content. The digital content may be movie, music, and so forth. The plurality of audio sources, which are data constituting audio service, include sound effects, actor voices, background music, and so forth.

In order to receive a plurality of audio sources, there may be a plurality of the input units 210, or single audio service is received and then a plurality of audio sources may be extracted from the single audio service.

The amplifier 220 amplifies each of the plurality of audio sources input through the input unit 220 and outputs the amplified audio sources to the multiplexer 230.

The multiplexer 230 composes a plurality of audio streams by classifying the plurality of amplified audio sources by the type, and multiplexing each of the plurality of classified audio sources.

Hereinafter, the input unit 210 and the multiplexer 230, which compose a plurality of audio streams, will be explained in detail with reference to FIG. 3.

FIG. 3 is a block diagram illustrating a process of composing an audio stream of an audio stream transmission apparatus, according to an exemplary embodiment. As illustrated in FIG. 3, an audio stream transmission apparatus that composes a plurality of audio streams includes a plurality of input units 210-1, 210-2, . . . , 210-6, a plurality of amplifiers 220-1, 220-2, . . . , 220-6, and a plurality of multiplexers 230-1, 230-2, . . . , 230-3. In this case, digital contents input to the audio stream transmission apparatus 200 are movie contents.

If movie contents are input to the audio stream transmission apparatus 200, the plurality of input units 210-1, 210-2, . . . , 210-6 receive a plurality of audio sources constituting audio service of the movie contents. Specifically, the first input unit 210-1 receives a first sound effect source, the second input unit 210-2 receives a second sound effect source, the third input unit 210-3 receives a first actor voice source, the fourth input unit 210-4 receives a second actor voice source, the fifth input unit 210-5 receives a first background music source, and the sixth input unit 210-6 receives a second background music source. In this case, the first sound effect source, the first actor voice source, and the first background music source are audio sources of a right channel, respectively. The second sound effect source, the second actor voice source, and the second background music source are audio sources of a left channel, respectively.

If a plurality of audio sources that comprise the audio service are input, the plurality of amplifiers 220-1, 220-2, . . . , 220-6 amplify each of the plurality of input audio sources. Specifically, the first amplifier 220-1 amplifies a first sound effect source, the second amplifier 220-2 amplifies a second sound effect source, the third amplifier 220-3 amplifies a first actor voice, the fourth amplifier 220-4 amplifies a second actor voice, the fifth amplifier 220-5 amplifies a first background music source, and the sixth amplifier 220-6 amplifies a second background music source.

The plurality of multiplexers 230-1, 230-2, 230-3 compose a plurality of audio streams by classifying the plurality of amplified audio sources by the type, and multiplexing each of the plurality of classified audio sources of the classified types. Specifically, the plurality of multiplexers 230-1, 230-2, 230-3 multiplex audio sources by classifying a left audio source and a corresponding right audio source as one group having the same type. For example, the first multiplexer 230-1 multiplexes the first sound effect source and the second sound effect source, the second multiplexer 230-2 multiplexes the first actor voice source and the second actor voice source, and the third multiplexer 230-3 multiplexes the first background music source and the second background music source.

As described above, a plurality of audio streams are composed as corresponding left and right audio sources are multiplexed. That is, the fist sound effect source and the second sound effect source constitute a first audio stream, the first actor voice and the second actor voice constitute a second audio stream, and the first background music source and the second background music source constitute a third audio stream.

As described above, the audio stream transmission apparatus 200 may compose a plurality of audio streams by classifying audio sources included in single audio service by type.

The RS encoder 240 encodes a plurality of audio streams composed by the plurality of multiplexers 230-1, 230-2, 230-3. In addition, the RS encoder 240 performs forward error correction (FEC) coding. The FEC coding is also referred to as a self-correction method, and utilizes redundant bits to allow the receiver to detect and correct the detected errors.

The interleaver 250 interleaves a plurality of audio streams which are encoded by the RS encoder 240. Interleaving is performed to rearrange data rows by certain units, so that even if some bits are lost in the middle of the data due to noise, the lost part can be restored.

The trellis encoder 260 performs trellis-encoding on the plurality of interleaved audio streams. The modulator 270 modulates the plurality of trellis-encoded audio streams and outputs the modulated audio streams.

The audio stream transmission apparatus 200 may compose a single audio service with a plurality of audio streams, and transmit the plurality audio streams to the audio stream reception apparatus 400, which will be explained later.

Audio Stream Reception Apparatus

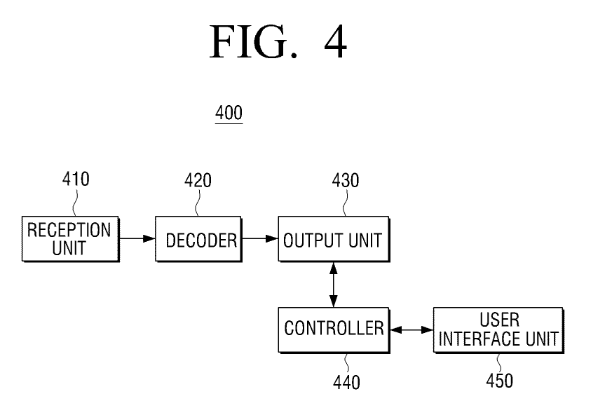

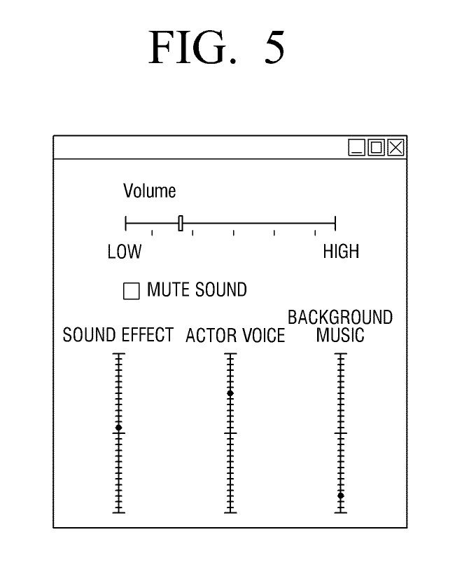

Hereinafter, an audio stream reception apparatus, according to an exemplary embodiment, will be explained with reference to FIGS. 4 and 5.

FIG. 4 is a schematic block diagram illustrating an audio reception apparatus 400, according to an exemplary embodiment. As illustrated in FIG. 4, the audio stream reception apparatus 400 includes a reception unit 410, a decoder 420, an output unit 430, a controller 440, and a user interface unit 450.

The reception unit 410 receives an audio signal, which includes a plurality of audio streams, transmitted from a source, such as the audio stream transmission apparatus 200, and performs signal-processing on the received audio signal. Specifically, the reception unit 410 comprises a tuner (not shown), a demodulator (not shown), and an equalizer (not shown). The tuner performs tuning on a received audio signal, the demodulator detects sync of the tuned signal and demodulates the tuned signal, and the equalizer performs equalizes the demodulated signal to compensate for channel distortion of the demodulated signal.

In this case, the received audio signal includes a plurality of audio streams constituting a single audio service, and each of the plurality of audio streams are composed as a plurality of audio sources classified by the type and multiplexed.

For example, if the single audio service is audio service of movie contents, the first audio stream is consisted of the first sound effect and the second sound effect, the second audio stream is consisted of the first actor voice and the second actor voice, and the third audio stream is consisted of the first background music and the second background music, as illustrated in FIG. 3.

The decoder 420 decodes a plurality of audio streams, which are received and signal-processed by the reception unit 410. Specifically, the decoder 420 comprises a trellis decoder (not shown), a de-interleaver (not shown), an RS decoder (not shown), and a de-multiplexer (not shown). The trellis decoder (not shown), the de-interleaver (not shown), the RS decoder (not shown), and the de-multiplexer (not shown) performs reverse operations of the trellis decoder 260, the interleaver 250, the RS encoder 240, and the multiplexer 230, respectively, which are described above with reference to FIG. 2.

The output unit 430 outputs a plurality of audio streams, which are decoded by the decoder 420. In addition, the output unit 430 includes an amplifier (not shown) that amplifies each of the plurality of audio streams according to a user's adjustment command.

The controller controls an overall operation of the audio stream reception apparatus 400, according to a user's command received from a user manipulation unit (not shown) and the user interface unit 450.

The controller 440 may control output status of each of the plurality of audio streams individually. Specifically, the controller 440 may control output status of each of the plurality of audio streams in accordance with a user's command input through the user interface unit 450.

The user interface unit 450 receives a user's command to adjust volume of an audio source included in each of the plurality of audio streams. Herein, the user interface unit 450 includes a plurality of volume adjustment command bars corresponding to the plurality of audio streams. Specifically, if the single audio service is audio service regarding movie contents, a plurality of volume adjustment command bars to adjust sound effects, actor voices, and background music respectively may be included, as illustrated in FIG. 5.

In this case, the controller 440 controls output of the plurality of audio streams by controlling an amplifier of the output unit 430 in accordance with a command input through the plurality of volume adjustment command bars. For example, if a command to increase actor voice volume and to decrease background music volume is input through the user interface unit 450, the controller 440 controls an amplifier of the output unit 430 to increase volume of an audio stream corresponding to actor voice and decrease volume of an audio stream corresponding to background music.

Accordingly, a user may control output of each of a plurality of audio sources (for example, sound effect, actor voice, background music, and so forth) which constitute single audio service of movie contents.

Audio Stream Transmitting Method

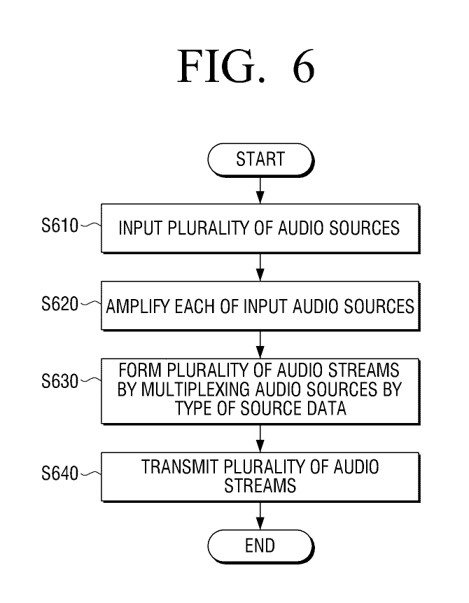

Hereinafter, a method of transmitting an audio stream of the audio stream transmission apparatus 200 will be explained, with reference to FIG. 6.

The audio stream transmission apparatus 200 receives a plurality of audio sources that constitute a single audio service (S610). The audio stream transmission apparatus 200 amplifies each of the plurality of input audio sources (S620).

Subsequently, the audio stream transmission apparatus 200 composes a plurality of audio streams by multiplexing audio sources according to the type of the audio sources. Specifically, the audio stream transmission apparatus 200 classifies a left audio source and a right audio source, which correspond with each other, as a group having the same type and multiplexes the classified audio sources. For example, the audio stream transmission apparatus 200 multiplexes the first sound effect source and the second sound effect source, multiplexes the first actor voice source and the second actor voice source, and multiplexes the first background music source and the second background music source.

As described above, the audio stream transmission apparatus 200 composes a plurality of audio streams by multiplexing a left audio source and a right audio source, which correspond with each other. That is, the first sound effect source and the second sound effect source constitute the first audio stream, the first actor voice and the second actor voice constitute the second audio stream, and the first background music source and the second background music source constitute the third audio stream.

The plurality of audio streams which are formed, as described above, undergo signal-processing, such as RS-encoding, interleaving, trellis-encoding and modulating, and are transmitted to the audio stream reception apparatus 400 (S640).

Audio Stream Receiving Method

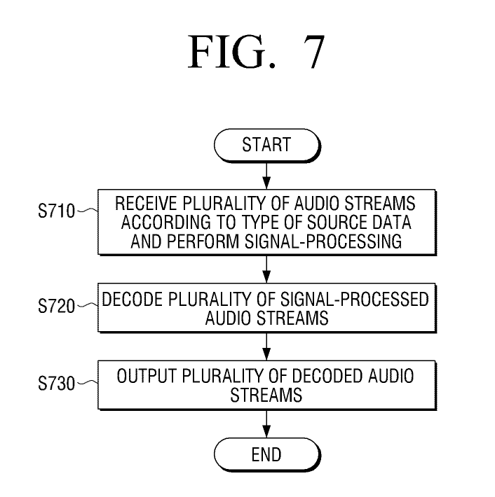

Hereinafter, a method for receiving an audio stream of the audio stream reception apparatus 400 will be explained, with reference to FIG. 7.

The audio stream reception apparatus 400 receives a plurality of audio streams from the audio stream apparatus 200 (S710). Each of the plurality of received audio streams are composed as a plurality of audio sources classified by type and multiplexed. The plurality of received audio streams undergo signal-processing, such as tuning, modulating, and equalizing.

The audio stream reception apparatus 400 decodes a plurality of signal-processed audio streams (S720). Specifically, the audio stream reception apparatus 400 performs decoding, such as trellis-decoding, de-interleaving, RS-decoding, and de-multiplexing, on the plurality of signal-processed streams.

The audio stream reception unit 400 outputs the plurality of decoded audio streams (S730). In this case, the audio stream reception apparatus 400 may control an output status of each of the plurality of audio streams individually, in accordance with a user's command input through a user interface.

As described above, output status of each audio stream corresponding to an audio source can be individually controlled. Therefore, a user may build a desired audio environment.

Other Exemplary Embodiments

In the above exemplary embodiment, a multiplexer performs multiplexing by classifying audio sources by the type, but this is only an example. The technical feature of the application may be applied when the multiplexer performs multiplexing by classifying audio sources by the language, according to language information of the plurality of audio sources.

Specifically, if audio sources constituting a single audio service are consisted of various languages (for example, English, Korean, French, and so forth), the audio stream transmission apparatus 200 may compose a plurality of audio streams by classifying audio sources by the language and multiplexing the classified audio sources.

For example, if a plurality of audio sources constituting a single audio service include a first English source, a second English source, a first Korean source, a second Korean source, a first French source, and a second French source, the audio stream transmission apparatus 200 may compose the first audio stream to the third audio stream by multiplexing each of the first English source the second English source, the first Korean source and the second Korean source, and the first French source and the second French source.

In the above exemplary embodiment, audio service is set to be audio service regarding audio contents, but this is only an example. The technical feature of the application may be applied to audio service of other contents. For example, the audio service may be audio service regarding music contents, news contents, and so forth.

The exemplary embodiments can also be embodied as computer readable codes on a computer readable recording medium. The computer readable recording medium is any data storage device that can store data, which can be thereafter read by a computer system to execute the computer readable codes stored thereon.

The apparatuses illustrated in FIGS. 2 and 4 may include a bus coupled to every unit of the apparatus, at least one processor connected to the bus, and memory connected to the bus to store commands, receive messages, and generate messages, and the processor executes the commands and controls the operations of the apparatuses.

Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. In an alternative embodiment, the exemplary embodiments can also be embodied as computer readable transmission media, such as carrier waves, for transmission over a network.

As described above, according to various exemplary embodiments, each of a plurality of audio sources of a single audio service may be formed as a plurality of audio streams. Therefore, a user may build a desired audio environment by adjusting output of each of the plurality of audio streams.

Although a few exemplary embodiments have been shown and described, it will be appreciated by those skilled in the art that changes may be made in the exemplary embodiments without departing from the principles and spirit of the invention, the scope of which is defined in the claims and their equivalents.

What is claimed is:

1. A stream transmission apparatus comprising:
a plurality of input units that respectively receive an audio source from among a plurality of audio sources of a single audio service; and
a plurality of multiplexers that classify each of the plurality of audio sources by type of audio source, group the plurality of classified audio sources having a same classified type together, and multiplex audio sources within the classified groups of audio sources together as a plurality of audio streams.

2. The stream transmission apparatus as claimed in claim 1, further comprising:
a plurality of amplifiers that respectively amplify the plurality of audio sources received by the plurality of input units and respectively provide a plurality of amplified audio sources to the plurality of multiplexers.

3. The stream transmission apparatus as claimed in claim 1, wherein each of the plurality of multiplexers classifies a left source among the plurality of audio sources and a corresponding right source among the plurality of audio sources as a same type and multiplexes the classified left source and corresponding right source together.

4. The stream transmission apparatus as claimed in claim 1, wherein the plurality of audio sources comprises a left source and right source of at least one of an actor voice, a sound effect, and a background music.

5. The stream transmission apparatus as claimed in claim 1, wherein each of the plurality of multiplexers classifies the plurality of audio sources using a same language into a group according to language information of the plurality of audio sources and multiplexes the classified audio sources having a same language together.

6. The stream transmission apparatus as claimed in claim 1, further comprising:
a Reed-Solomon (RS) encoder which RS-encodes the plurality of audio streams multiplexed by the plurality of the multiplexers;
an interleaver which interleaves the plurality of RS-encoded audio streams;
a trellis-encoder which trellis-encodes the plurality of interleaved audio streams; and
a modulator which modulates the plurality of trellis-encoded audio streams and outputs the plurality of modulated audio streams.

7. A stream transmitting method, the method comprising:
receiving a single audio service, the single audio service comprising a plurality of audio sources;
classifying each the plurality of audio sources according to a type of each of the plurality of audio sources;
grouping the plurality of classified audio sources having a same classified type together; and
multiplexing audio sources within the classified groups of audio sources together as a plurality of audio streams.

8. The method as claimed in claim 7, further comprising:
amplifying each of the received plurality of audio sources, and
wherein the multiplexing comprises multiplexing amplified audio sources within the classified groups of amplified audio sources together as the plurality of audio streams.

9. The method as claimed in claim 7, wherein the classifying comprises classifying a left source among the plurality of audio sources and a right corresponding right source among the plurality of audio sources as a same type, and
wherein the multiplexing comprises multiplexing the classified left source and corresponding right source together.

10. The method as claimed in claim 7, wherein the plurality of audio sources comprises a left source and right source of at least one of an actor voice, a sound effect, and a background music.

11. The method as claimed in claim 7, wherein the classifying comprises classifying the plurality of audio sources using a same language into a group according to language information of the plurality of audio sources, and
wherein the multiplexing comprises multiplexing the classified audio sources having a same language together.

12. A stream reception apparatus comprising:
a reception unit which receives a plurality of audio streams that form a single audio service; and
a decoder which decodes the plurality of audio streams,
wherein each of the plurality of audio streams comprises a multiplexed audio stream, the multiplexed audio stream comprising a plurality of audio sources classified as a same type of audio source.

13. The stream reception apparatus as claimed in claim 12, further comprising:
a controller which individually outputs each of the plurality of audio streams.

14. The stream reception apparatus as claimed in claim 13, further comprising:
a user interface unit which receives a volume adjustment command that instructs the reception apparatus to adjust a volume of an audio source among the plurality of audio sources included in an audio stream among the plurality of audio streams,
wherein the controller controls the stream reception apparatus to adjust the volume of the audio source and output the adjusted audio source in accordance with the volume adjustment command.

15. The stream reception apparatus as claimed in claim 14, wherein the user interface unit includes a plurality of volume adjustment bars corresponding to the plurality of audio streams.

16. A stream receiving method, comprising:
receiving a plurality of audio streams that form a single audio service; and
decoding the plurality of audio streams,
wherein each of the plurality of audio streams comprises a multiplexed audio stream, the multiplexed audio stream comprising a plurality of audio sources classified as a same type of audio source.

17. The method as claimed in claim 16, further comprising:
individually outputting each of the plurality of audio streams.

18. The method as claimed in claim 17, further comprising:
receiving a volume adjustment command to adjust a volume of an audio source among the plurality of audio sources included in an audio stream among the plurality of audio streams;
adjusting the volume of the audio source; and
outputting the adjusted audio source in accordance with the input volume adjustment command.
